(19) United States
(12) Patent Application Publication
(10) Pub. No.: US 2017/0372504 A1
(43) Pub. Date: Dec. 28, 2017

(54) METHOD AND SYSTEM FOR GENERATING 3D SYNTHETIC IMAGE BY COMBINING BODY DATA AND CLOTHES DATA

(71) Applicant: Seuk Jun JANG, Hwaseong-si (KR)

(72) Inventor: Seuk Jun JANG, Hwaseong-si (KR)

(21) Appl. No.: 15/537,937

(22) PCT Filed: Dec. 22, 2015
(86) PCT No.: PCT/KR2015/014104

§ 371 Date: Jun. 20, 2017

(30) Foreign Application Priority Data
Dec. 22, 2014 (KR) 10-2014-0185780

(51) Int. Cl. G06T 13/40; G06Q 30/06; G06T 19/00; G06T 19/20

(52) U.S. Cl. CPC G06T 13/40; G06T 19/20; G06Q 30/0641; G06T 19/006

(57) ABSTRACT

The present invention relates to a method and a system for generating a 3D manipulated image acquired by combining physical data and clothing data, and more particularly, to a method and a system for generating a 3D manipulated image acquired by combining physical information of a user, data acquired by scanning clothing, and unique information of fabric used in making the clothing. To this end, a method for generating a 3D manipulated image by combining data acquired by clothing with data acquired by scanning a body of a user includes: adjusting a distance between clothing cloud data by combining physical cloud data representing a body of a user, clothing cloud data representing clothing, unique information of fabric constituting the clothing, and the unique information of the clothing; generating 3D manipulated data acquired by synthesizing the body and the clothing of the user; and generating a contour line from the 3D manipulated data and generating colors to generate the 3D manipulated image.

### TECHNICAL FIELD

The present invention relates to a method and a system for generating a 3D manipulated image acquired by combining physical data and clothing data.

### BACKGROUND ART

Modern people who emphasize personality have become generalized to use the Internet as a means of acquiring information to find current trendy fashion and fashion suitable therefor. Due to this trend, a variety of shopping malls have emerged on the Internet, and one of the most popular fields is clothing and a fashion product mall including the same. Users purchasing fashion products using the Internet make full use of the temporal and spatial freedom provided by the Internet to purchase and use desired products without using any physical effort at a desired time.

When a user confirms an image provided on a web page of the fashion product mall and is interested in the image of a posted product, the user selects the image and confirms detailed information and purchase the product through the detailed information.

In such a purchase scheme, in the case of the fashion product, when a product that seems good in the image is received, the user often gets a different feeling from the image with respect to the image of the product, and as a result, the product is returned and turned back, which results in temporal and monetary damages to a mall operator, a product producer, and a product purchaser.

In order to solve such a problem, contrived is a method for providing fashion information through the Internet. The method of providing the fashion information through the Internet includes a method for providing a coordination service that displays user information in a database and compositing the product and a body form, or providing a coordination solution by creating a virtual model input by the user and pre-fitting a product selected by the user from image data regarding clothing products, that is, clothes, spectacles, shoes, caps, and the like.

However, since the coordination service on the Internet is provided by using the virtual model in a cyberspace rather than a real thing, when the user actually wears the fashion product such as the clothing or the cap, it may not be confirmed whether the product is in an entire harmony with his or her taste, physical characteristics, skin, and a hair color, and as a result, after the purchase of the product, the user is not satisfied with the product and the product is frequently returned.

In addition, a consumer goes to an off-line department store or shopping mall and tries to wear the clothing and thereafter, may not determine whether the clothing matches the consumer and when the consumer comes home and tries to wear the clothing after purchasing the clothing or frequently judges that the clothing does not match the consumer at the time of listening to opinions of other people. Therefore, the clothing is also frequently returned or exchanged.

The consumer tries the clothes offline and thereafter, may return the fashion product even after purchasing the fashion product and a natural result is that product satisfaction of the consumer with the fashion product purchased by the consumer on the Internet cannot but be much lower.

Due to these problems, an online shopping service is still inferior in reliability and satisfaction to the consumer.

### PRIOR ART DOCUMENT

### Patent Document

Korean Patent Unexamined Publication No. 2010-0048733

Korean Patent Unexamined Publication No. 2012-019410

### DISCLOSURE

### Technical Problem

An object to be solved by the present invention is to propose a scheme that generates a 3D manipulated image using unique information of fabrics fabricated from clothing in addition to clothing scan information obtained by scanning the clothing.

Another object to be solved by the present invention is to propose a scheme that generates a 3D manipulated image by using clothing point cloud data or mesh data having a relatively smaller data capacity than scan data obtained by scanning the clothing and combines the scan data with the manipulated image to express a color.

Yet another object to be solved by the present invention is to propose a scheme that generates a 3D manipulated image by using clothing point cloud data convertible according to physical point cloud data of a user.

Still yet another object to be solved by the present invention is to propose a scheme that generates the 3D manipulated image by using the clothing point cloud data varied according to the number or the thickness of clothing worn on a body of the user.

### Technical Solution

To this end, a method for generating a 3D manipulated image by combining data acquired by clothing with data acquired by scanning a body of a user according to an aspect of the present invention, includes: adjusting a distance between clothing cloud data by combining physical cloud data representing a body of a user, clothing cloud data representing clothing, unique information of fabric constituting the clothing, and the unique information of the clothing; generating 3D manipulated data acquired by synthesizing the body and the clothing of the user; and generating a contour line from the 3D manipulated data and generating colors to generate the 3D manipulated image. Further, the method for generating a 3D manipulated image may further include: generating user point cloud data representing an outer shape of the body of the user; and generating clothing point cloud data representing the outer shape of the clothing, and the physical cloud data and the clothing cloud data may be constituted by point cloud data.

In addition, the method for generating a 3D manipulated image may further include: generating user mesh data representing the outer shape of the body of the user; and generating clothing mesh data representing the outer shape of the clothing, and the physical cloud data and the clothing cloud data are constituted by mesh data.

Moreover, in the generating of the user point cloud data, the user point cloud data may be generated by scanning the body of the user.

Further, in the generating of the clothing point cloud data, the clothing point cloud data may be generated by scanning the clothing.

In addition, in the generating of the clothing point cloud data, the clothing point cloud data may be generated from an input 3D image file of the clothing.

Further, the adjusting of the distance between the clothing cloud data may include setting a plurality of reference points in the clothing point cloud data, adjusting the distance between the reference points, and adjusting a detailed interval of adjusting the distance between respective point cloud data from the reference point.

Moreover, the adjusting of the detailed interval may include calculating volumes of parts of the body of the user, calculating stress applied to each part of the clothing, and calculating an extensible distance according to a characteristic of the fabric.

Further, the adjusting of the distance between the clothing cloud data may include setting a movement direction of the clothing point cloud data.

In addition, in the adjusting of the distance between the clothing cloud data, a plurality of curvature points which contact the body may be extracted from the clothing point cloud data and a shape change of the clothing point cloud data may be calculated at the curvature points.

Further, the unique information regarding the fabric may be constituted by at least one of a type and elasticity of a fiber, a thickness of fabric, a weight per area of the fabric, permeability of the fabric, a tensile strength, a tear strength, an abrasion strength, heat resistance, moisture mobility, firmness, drapability, peeling, filling, a spinning property, a strength of a thread, the spinning property, evenness of the thread, curving and bending characteristics, and fillability.

In addition, the generating of the 3D manipulated image may include synthesizing first clothing point cloud data representing the outer shape of first clothing with the point cloud data of the user, and synthesizing second clothing point cloud data representing the outer shape of second clothing after synchronizing the first clothing point cloud data, and the size of the clothing corresponding to the second clothing point cloud data may be calculated according to the size of the clothing corresponding to the first clothing point cloud data and the thickness of the first clothing.

Further, the method for generating a 3D manipulated image may further include: after the generating of the 3D manipulated image, rotating the 3D manipulated image at a set rotational speed, and a motion of the clothing constituting the 3D manipulated image may be expressed according to the unique information of the clothing corresponding to the clothing point cloud data synthesized with the user point cloud data.

In addition, the method for generating a 3D manipulated image may further include: receiving the unique information of the user, and the unique information of the user may be at least one of an age, a gender, a hair color, and a weight of the user.

Further, in the generating of the 3D manipulated image, when at least two clothes corresponding to the clothing point cloud data to be synthesized with the user point cloud data are selected, the clothing point cloud data corresponding two clothes selected according to the unique information of the clothing may be automatically synthesized with the user point cloud data in sequence.

A system for generating a 3D manipulated image according to another aspect of the present invention includes: a user scanner generating user point cloud data representing an outer shape of a body from data acquired by scanning body of a user and transmitting the generates user point cloud data and unique information of the user; and a system operator server generating the 3D manipulated image acquired by synthesizing the body and clothing of the user by combining the user point cloud data, clothing point cloud data, received unique information of fabric constituting the clothing, and the unique information of the clothing.

Further, the system operator server may include a clothing point cloud data generating unit generating clothing point cloud data representing an outer shape of the clothing from data acquired by scanning the clothing.

In addition, the system operator server may include a reference point setting unit setting a plurality of reference points in the clothing point cloud data, a reference point adjusting unit adjusting a distance between the reference points, and a point cloud data detail adjusting unit adjusting the distance between respective point cloud data from the reference point.

Further, the point cloud data detail adjusting unit may include a physical analyzing unit calculating volumes of parts of the body of the user, a stress calculating unit calculating stress applied to each part of the clothing, and an elasticity calculating unit calculating an extensible distance of the clothing.

In addition, the system operator server may further include a shape control unit, and the shape control unit may extract a plurality of curvature points which contact the body from the clothing point cloud data and calculate a shape change of the clothing point cloud data at the curvature points.

### Advantageous Effects

A method and a system for generating a 3D manipulated image acquired by combining physical data and clothing data generate the 3D manipulated image by combining scan data acquired by scanning a body of a user, scan data acquired by scanning clothing, and unique information of the clothing to generate the 3D manipulated image to which a unique characteristic of the clothing is reflected.

Further, according to the present invention, the number or the thickness of the clothing worn on the scan data (alternatively, user point cloud data) acquired by scanning the body of the user is reflected to generate the 3D manipulated image. According to the present invention, the 3D manipulated image is generated by using the unique information of the clothing to generate an image having the same effect as a case where the user actually wears the clothing. Further, when a system operator server receives information on the clothing from a clothing making company, the system operator server can conveniently manage unique information regarding the clothing.

In addition, data acquired by partially modifying scan data acquired by scanning the clothing by considering the 3D manipulated data is provided to the clothing making company to manufacture customized clothing of the user.

### DESCRIPTION OF DRAWINGS

FIG. 1 is a diagram schematically illustrating a configuration of generating a 3D manipulated image according to an embodiment of the present invention.

FIG. 2 illustrates the configuration of a user scanner according to the embodiment of the present invention.

FIG. 3 is a block diagram illustrating the configuration of a system operator server according to the embodiment of the present invention.

FIG. 4 illustrates an example of manipulating clothing manufactured by a fabric having different elasticity with a body according to the embodiment of the present invention.

FIG. 5 illustrates an example of modifying clothing point cloud data by reflecting physical point cloud data according to the embodiment of the present invention.

FIG. 6 is a flowchart illustrating a method for generating a 3D manipulated image according to an embodiment of the present invention.

FIG. 7 is a flowchart illustrating a process of adjusting a distance between cloud data according to an embodiment of the present invention.

### MODE FOR INVENTION

The present invention may have various modifications and various embodiments and specific embodiments will be illustrated in the drawings and described in detail. However, this does not limit the present invention to specific embodiments, and it should be understood that the present invention covers all the modifications, equivalents and replacements included within the idea and technical scope of the present invention.

Terms including an ordinary number, such as first and second, are used for describing various constituent elements, but the constituent elements are not limited by the terms. The terms are used only to discriminate one constituent element from another component.

For example, a first component may be referred to as a second component, and similarly, the second component may be referred to as the first component without departing from the scope of the present invention. A term ‘and/of includes a combination of a plurality of associated disclosed items or any item of the plurality of associated disclosed items.

If it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

Hereinafter, the present invention and preferred embodiments of the present invention will be described in detail with reference to the accompanying drawings.

FIG. 1 is a diagram schematically illustrating a configuration of generating a 3D manipulated image according to an embodiment of the present invention. Hereinafter, the configuration of generating the 3D manipulated image will be described by using FIG. 1.

According to FIG. 1, the configuration of generating the 3D manipulated image includes a system operator server 100 and a user scanner 200 and the system operator server 100 includes a clothing data generating unit 110, a 3D manipulated image generating unit 120, a control unit 30, a storage server 150, and an input unit 140. Further, the user scanner 200 includes a 3D scanner 205, a communication unit 220, a control unit 225, an input unit 210, and a storage unit 215. Of course, another configuration other than the aforementioned configuration may be included in a configuration of generating the 3D manipulated image proposed by the present invention.

The system operator server 100 scans clothing by using the 3D scanner. The system operator server 100 generates scanning data regarding the scanned clothing.

The system operator server 100 generates clothing cloud data by using the generated scanning data. However, the present invention is not limited thereto and the system operator server 100 may generate point cloud data regarding a clothing data by using another apparatus other than the 3D scanner. Therefore, the system operator server 100 may generate the clothing point cloud data in a 3D image file provided from a clothing maker.

Hereinafter, data to generate a shape of the clothing may be defined as clothing cloud data, and the clothing cloud data may be configured by the point cloud data and configured by mesh data. However, when the cloud data is configured by the point cloud data, a capacity is small, and as a result, a data processing speed may be remarkably increased as compared with the mesh data or shape data.

The system operator server 100 generates clothing point cloud data or clothing mesh data to generate the shape of the clothing. To this end, sensors may be attached to the clothing at a predetermined interval and the attached sensors may measure a relative distance between the sensors through mutual communication between the sensors. The system operator server 100 generates the clothing cloud data by using relative distance information received from the sensors. However, the present invention is not limited thereto and the system operator server 100 may generate the clothing point cloud data by various methods other than the aforementioned method.

The system operator server 100 receives data regarding the clothing and a fabric through the input unit. That is, the system operator server 100 receives unique information regarding the clothing and the fabric through the input unit. This will be described below.

As described above, the system operator server 100 according to the present invention just generates the 3D manipulated image by using data regarding the shape or a color of the clothing and the unique information regarding the fabric used in making the clothing.

The user scanner 200 scans a whole body of a user. The user scanner 200 generates user point cloud data or user mesh data to generate a whole body shape of the user by using the generated scan data regarding the whole body of the user. The user scanner 200 receives the unique information of the user if necessary. The unique information of the user includes a name, an age (age range), a height, a weight, a gender, a hair color, a hair shape, and the like of the user. The user scanner 200 provides the user point cloud data and the unique information of the user to the system operator server 100.

The system operator server 100 generates the 3D manipulated image by synthesizing the user point cloud data, the unique information of the user, and the stored clothing point cloud data received from the user scanner 200. Of course, the system operator server 100 uses the unique information regarding the fabric in generating the 3D manipulated image. That is, when the received unique information of the fabric is different even though the user point cloud data and the clothing point cloud data are the same, a different image is also generated as the generated 3D manipulated image. Hereinafter, each component illustrated in FIG. 1 will be described in detail.

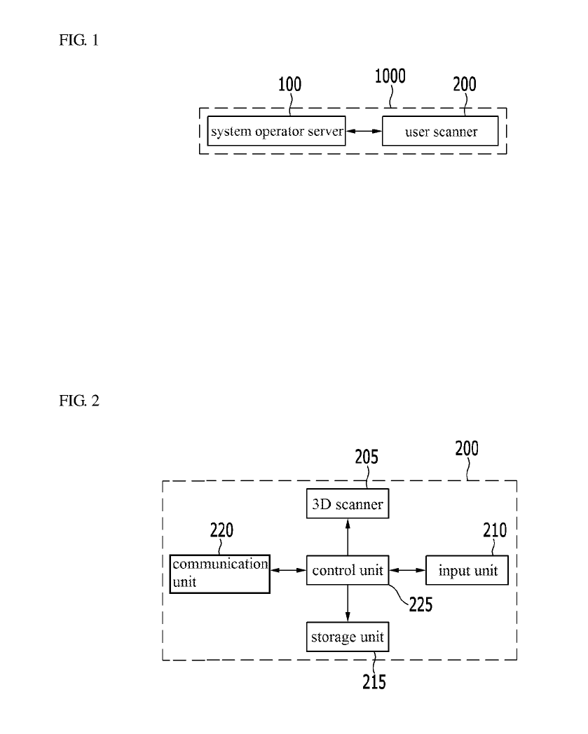

FIG. 2 illustrates the configuration of a user scanner according to the embodiment of the present invention. Hereinafter, the configuration of the user scanner according to the embodiment of the present invention will be described in detail with reference to FIG. 2.

According to FIG. 2, the user scanner includes the 3D scanner, the input unit, the storage unit, the communication unit, and the control unit. Of course, another configuration other than the aforementioned configuration may be included in the user scanner proposed by the present invention.

The 3D scanner 205 scans the whole body of the user. The 3D scanner 205 provides information on the scanned whole body of the user to the control unit 225. As described above, the user scanner may generate the user cloud data by using the sensors in addition to the 3D scanner. Herein, the cloud data may be configured by the point cloud data or the mesh data.

The input unit 210 receives the unique information of the user. As described above, the user's unique information includes the age, the gender, the height, the weight, the name, and the like of the user. Of course, another information other than the information may be included in the user's unique information.

The control unit 225 generates the user point cloud data by using the scan data received from the 3D scanner 205. That is, the control unit 205 generates the user point cloud data having a relatively smaller data size than the scan data. Since the user point cloud data is data to recognize the shape of the user, the user point cloud data is smaller than the scan data.

The control unit 225 partitions an intersection distance measured between the respective sensors, which is received from the sensors into vertical and horizontal components, calculates a physical size of the user by combining positional relationships between the vertical and horizontal components, and generates the user point cloud data by using the calculated physical size of the user.

The control unit 225 calculates a projection distance which is a distance at which a central intersection point is projected from a plane formed by a mesh based on a diagonal distance which is a measurement distance from the sensors positioned at outer periphery intersection points which are eight intersection points positioned on outer peripheries of four adjacent meshes up to the central intersection point which is the intersection point at the center of four meshes.

Further, the control unit 225 increases the measured physical size by a predetermined amount and outputs the increased physical size when the projection distance is equal to or more than a predetermined threshold value. When the projection distance is contiguously generated at a predetermined number of times as the projection distance is progressed in horizontal and vertical directions, the control unit 225 increases the measured physical size by the predetermined amount and outputs the increased physical size. Further, it is preferable to use an ultrasonic distance sensor as the sensor.

The storage unit 215 stores the received user's unique information, scan data, and user point cloud data. Further, the storage unit 215 stores data required for driving the user scanner.

The communication unit 220 performs communication with the external system operator server 100. The communication unit 220 transmits the data regarding the whole body of the user, which is scanned by the 3D scanner 205 to the external system operator server 100. Of course, the communication unit 220 may transmit the user point cloud data in addition to the scan data. Besides, the communication unit 220 transmits the user's unique information to the external system operator server 100.

The communication unit 220 receives the 3D manipulated image from the external system operator server 100. Besides, the communication unit 220 transmits various information to the system operator server 100.

FIG. 2 illustrates that the input unit 210 is included in the use scanner 200, but the present invention is not limited thereto. That is, the input unit 210 may be included in a separate apparatus in addition to the user scanner.

The input unit 210 may select one of multiple clothes display in a display unit (not illustrated). That is, the display unit displays clothing to be synthesized with the body of the user, which is scanned by the 3D scanner. To this end, the display unit may divide and display the clothes into multiple groups. That is, the clothes may be divided into upper and lower clothes or displayed in various types including an inner wear, an overcoat, and the like.

The input unit 210 selects the clothing to be synchronized with the body of the user among multiple clothes displayed in the display unit. Of course, when necessary, the display unit may display detailed information regarding the clothing selected by the user.

The clothing (alternatively, clothing information) selected by the input unit 210 is transmitted to the external system operator server 100 through the communication unit 220. When additionally described, when the number of clothes selected through the input unit 210 is at least two, whenever the clothing is selected, the information on the selected clothing may be transmitted to the system operator server 100 or when all clothes are selected, the information on the selected clothes may be transmitted to the system operator server 100. As described above, the user may transmit the information on the clothes selected by various methods to the system operator server when necessary.

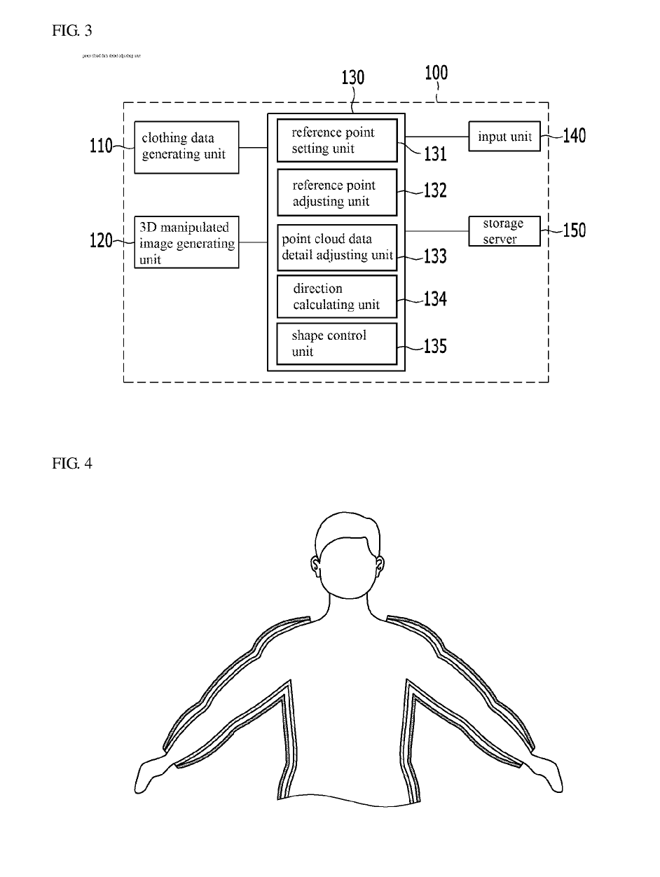

FIG. 3 is a block diagram illustrating the configuration of a system operator server according to the embodiment of the present invention. Hereinafter, the configuration of the system operator server according to the embodiment of the present invention will be described in detail with reference to FIG. 3.

According to FIG. 3, the system operator server 100 includes a clothing data generating unit 110, a 3D manipulated image generating unit 120, a control unit 130, the input unit 140, and a storage server 150. Of course, another configuration other than the aforementioned configuration may be included in the system operator server proposed by the present invention.

The clothing data generating unit 110 may generate the clothing cloud data by scanning the clothing by means of the scanner. The clothing data generating unit 110 may generate the point cloud data or the mesh data. Further, the clothing data generating unit 110 may generate the point cloud data from a 3D image.

The storage server 150 stores information on the clothing scanned by the clothing data generating unit 110. The storage server 150 stores the clothing point cloud data which is the point cloud data for the scanned clothing. Besides, the storage server 150 stores various information. That is, the storage server 150 stores the unique information in the fabric used in making the clothing input through the input unit 140. The unique information regarding the fabric will be described below.

The input unit 140 receives the unique information regarding the fabric constituting the clothing and the unique information of the clothing. Herein, the unique information regarding the fabric may include a type and elasticity of a fiber, a thickness of fabric, a weight per area of the fabric, permeability of the fabric, a tensile strength, a tear strength, an abrasion strength, heat resistance, moisture mobility, firmness, drapability, peeling, filling, a spinning property, a strength of a thread, the spinning property, evenness of the thread, curving and bending characteristics, and fillability. Further, the unique information of the clothing may include the type, the use, a wearing portion, and the like of the clothing. The input unit 140 receives various information on the clothing. Further, the input unit 140 may receive various information including a price, an origin, a making date, and the like.

The control unit 130 controls an operation of the system operator server 100. Further, the control unit 130 may include a reference point setting unit 131, a reference point adjusting unit 132, a point cloud data detail adjusting unit 133, a direction calculating unit 134, and a shape control unit 135.

The reference point setting unit 131 sets a plurality of reference points among the clothing point cloud data. A reference point may be set at a predetermined interval and set at a portion which becomes a joint according to the shape of the clothing.

The reference point adjusting unit 132 calculates a distance between the reference points and moves the reference point. The reference point adjusting unit 132 calculates the distance between the reference points by combining the user point cloud data and the physical point cloud data and moves the reference point according to the calculated distance.

The point cloud data detail adjusting unit 133 adjusts the distance between the respective point cloud data from the reference point. The point cloud data detail adjusting unit 133 adjusts the distance between the respective point cloud data from the reference point and adjusts even the distance between the point cloud data.

The point cloud data detail adjusting unit 133 includes a physical analyzing unit, a clothing analyzing unit, a stress calculating unit, and an elasticity calculating unit. The physical analyzing unit calculates volumes of parts of the body of the user. The physical analyzing unit analyzes the volume by dividing the body of the user into the respective parts and for example, the physical analyzing unit may analyze the volume by dividing the body of the user into an arm, a chest, a shoulder, an abdomen, and the like.

The stress calculating unit calculates stress applied to the respective parts of the clothing. The stress calculating unit calculates a space which is accommodatable in the clothing and calculates and stores the stress applied to each clothing when the body is inserted into the clothing by the calculated space. The stress calculating unit may calculate the stress applied to the respective point cloud data. The elasticity calculating unit calculates an extensible distance for each part of the clothing by considering the unique information of the fabric and the shape of the clothing.

The direction calculating unit 134 sets a movement direction of the clothing point cloud data and calculates the movement direction of the clothing point cloud data by considering the stress applied to the clothing and the shape of the clothing. The movement direction of the clothing point cloud data may be determined by the stress and the elasticity.

The shape control unit 135 extracts a plurality of curvature points which contact the body from the clothing point cloud data and calculates a shape change of the clothing point cloud data at the curvature points. For example, the stress is not applied to the clothing by the body at a portion which contacts the shoulder, but the clothing droops by gravity, and as a result, the clothing shape is changed and the shape control unit 135 compares a length of the clothing and the length of the body with each other to calculate the shape change of the clothing.

Since the clothing point cloud data has a relatively smaller data capacity than the scan data of the clothing as described above, it may more efficiently to use the clothing point cloud data than to use the scan data. That is, the control unit 130 may generate data regarding clothes having different shapes by using the clothing point cloud data which has the relatively smaller data capacity.

The 3D manipulated image generating unit 120 generates the 3D manipulated image buy using the user point cloud data, the clothing point cloud data, and the unique information regarding the clothing according to a control command from the control unit 130. The 3D manipulated image generating unit 120 generates the 3D manipulated data acquired by the body and the clothing of the user and generates a contour line from the 3D manipulated data and combines the colors to generate the 3D manipulated image.

As described above, the clothing point cloud data acquired b y converting the scanned data just represents only the shape of the clothing and may not express the color or a material of the clothing. Therefore, the 3D manipulated image generating unit 120 generates the 3D manipulated image by reflecting the scan data expressing the color or the material of the clothing to the clothing point cloud data. The reason for separating and 3D-synthesizing the scan data is that since the scan data has a larger capacity than the point cloud data, when a fitting process is performed by using the point cloud data having the small capacity, the clothing may be fitted to the body at a more rapid speed.

The unique information regarding the fabric and the clothing is numerically stored in the storage server 150. The storage server 150 of the present invention stores the unique information regarding various fabrics and generates the 3D manipulated image by using the stored unique information.

That is, the existing 3D manipulated image may not show a unique characteristic with the clothing by just synthesizing the clothing with the body, but in the present invention, when the 3D manipulated image is generated, the 3D manipulated image is generated by reflecting the unique characteristics of the clothing and the fabric, and as a result, in spite of the clothes having the same shape and color, the 3D manipulated image showing different feelings according to the unique characteristics of the clothes may be generated. That is, the weight of the clothing having the relatively smaller thickness of the fabric may be smaller than that of the clothing having the relatively larger thickness.

The generated 3D manipulated image may be rotated at a predetermined speed so as to allow the user to know the feeling. When the generated 3D manipulated image may be rotated at the predetermined speed, the clothing having the relatively smaller weight moves (sways) more largely than the clothing having the relatively larger weight. The 3D manipulated image is rotated at the predetermined speed as described above to maintain a state relatively closest to a case where an actual user wears the clothing.

Further, the 3D manipulated image generating unit 120 generates the 3D manipulated image by using elasticity information of the fabric. That is, in spite of the clothes having the same shape, the 3D manipulated images are different from each other, which are generated according to the elasticity of the fabric. That is, in the case of clothing having the fabric which is high elastic (that is, excellent in stretchability), the clothing is in close contact with all planes of the body, while in the case of clothing having the fabric which is low elastic (that is, low in stretchability), the clothing is in close contact with the body only at a part of the body. In detail, in the case of the inner wear, since the clothing is made by the fabric having excellent elasticity, when the 3D manipulated image is generated, all planes of the clothing are in close contact with the body. In detail, in the case of the inner wear, since the clothing is made by the fabric having relatively low elasticity, when the 3D manipulated image is generated, some planes of the clothing are in close contact with the body. As described above, according to the present invention, the 3D manipulated image is generated by using various characteristics of the fabric used in making the clothing.

FIG. 4 illustrates an example of manipulating clothing manufactured by a fabric having different elasticity with a body according to the embodiment of the present invention. That is, referring to FIG. 4, the body wears two clothes and in particular, in the case of the wear positioned inside, an example of synchronizing the clothing made by the fabric having the relatively high elasticity with the body is illustrated and in the case of the clothing positioned outside, an example of synthesizing the clothing made by the fabric having the relatively low elasticity with the body is illustrated.

As described above, it can be seen that the clothing made by the fabric having the high elasticity is in close contact with the entirety of the body, while the clothing made by the fabric having the low elasticity is in close contact with a part of the body.

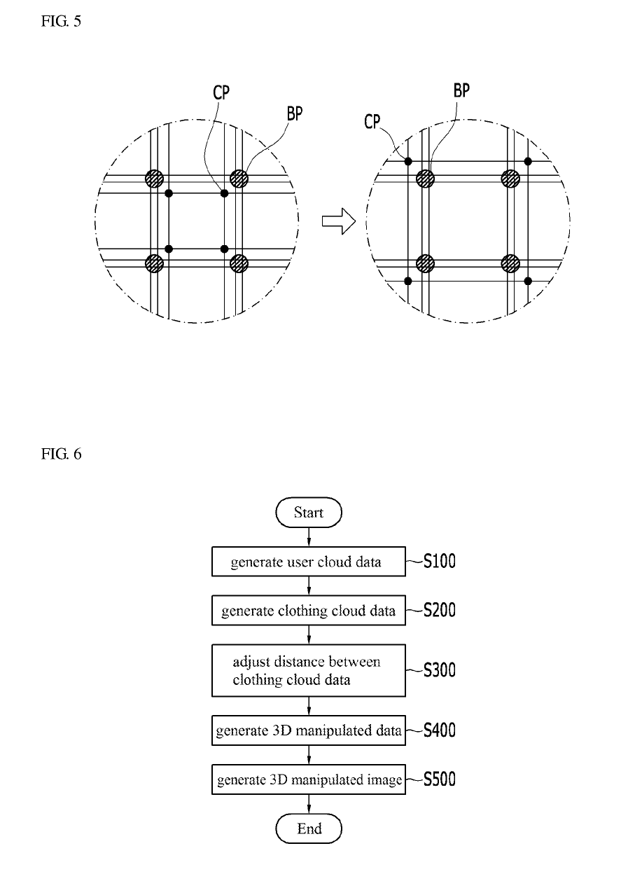

Further, FIG. 5 illustrates an example of modifying the clothing point cloud data to which the physical point cloud data is reflected. As illustrated in FIG. 5, the clothing point cloud data CP is modified according to the physical point cloud data BP and the unique information of the clothing and the fabric to generate the 3D manipulated image. That is, it can be seen that a distance between coordinates (point clouds) constituting the clothing point cloud data CP is increased by reflecting the physical point cloud data BP and the unique information of the clothing and the fabric. The 3D manipulated data is generated by synthesizing the scan data with the generated 3D manipulated point cloud data.

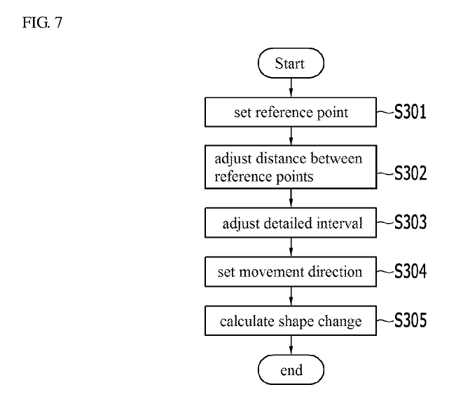

FIG. 6 is a flowchart illustrating a method for generating a 3D manipulated image according to an embodiment of the present invention. Hereinafter, the method for generating the 3D manipulated image according to the embodiment of the present invention will be described in detail with reference to FIG. 6.

The method for generating the 3D manipulated image according to the embodiment includes a step (S100) of generating user cloud data, a step (S200) of generating clothing cloud data, a step (S300) of adjusting a distance between the clothing cloud data, a step (S400) of generating 3D manipulated data, and a step (S500) of generating the 3D manipulated image.

In the step (S100) of generating the user cloud data, since user point cloud data or user mesh data representing an outer shape of a body of a user is generated, physical cloud data may be constituted by point cloud data or mesh data. In a step of generating the user point cloud data, the user point cloud data may be generated by scanning the body of the user by using a user scanner 200.

In the step (S100) of generating the user cloud data, the user point cloud data or user mesh data to generate a whole body shape of the user is generated by using scan data regarding a whole body of the user, which is generated by using the user scanner 200.

In the step (S100) of generating the user cloud data, a projection distance is calculated, which is a distance at which a central intersection point is projected from a plane formed by a mesh based on a diagonal distance which is a measurement distance from the sensors positioned at outer periphery intersection points which are eight intersection points positioned on outer peripheries of four adjacent meshes up to the central intersection point which is the intersection point at the center of four meshes.

Further, in the step (S100) of generating the user cloud data, the measured physical size is increased by a predetermined amount and the increased physical size is output when the projection distance is equal to or more than a predetermined threshold value. In the step (S100) of generating the user cloud data, when the projection distance is contiguously generated at a predetermined number of times as the projection distance is progressed in horizontal and vertical directions, the measured physical size is increased by the predetermined amount and the increased physical size is output.

In the step (S100) of generating the user cloud data, the received user's unique information, scan data, and user point cloud data are stored and data regarding the whole body of the user, which is scanned by the 3D scanner 205 is transmitted to the external system operator server 100.

The method for generating the 3D manipulated image may further include a step of receiving the user's unique information and the user's unique information may include a name, an age (age range), a height, a weight, a gender, a hair color, a hair shape, and the like of the user.

In the step (S200) of generating the clothing cloud data, the clothing cloud data representing the outer shape of the body of the clothing is generated, and as a result, the clothing cloud data may be constituted the point cloud data or the mesh data.

In the step (S200) of generating the clothing cloud data, scanning data regarding the clothing may be generated by scanning the clothing by means of the scanner and the clothing cloud data is generated by using the generated scanning data. However, the present invention is not limited thereto and the system operator server 100 may generate the point cloud data regarding a clothing design by using another apparatus other than the 3D scanner. Therefore, the system operator server 100 may generate the clothing point cloud data in a 3D image file provided from a clothing maker.

Hereinafter, data to generate a shape of the clothing may be defined as clothing cloud data, and the clothing cloud data may be configured by the point cloud data and configured by mesh data. However, when the cloud data is configured by the point cloud data, a capacity is small, and as a result, a data processing speed may be remarkably increased as compared with the mesh data or shape data.

In the step (S200) of generating the clothing cloud data, the clothing data generating unit 110 stores information on the scanned clothing and stores the clothing point cloud data which is the point cloud data regarding the scanned clothing.

In the step (S300) of adjusting the distance between the clothing cloud data, the distance between the clothing cloud data is adjusted by combining the physical cloud data representing the body of the user, the clothing cloud data representing the clothing, the unique information of the fabric constituting the clothing, and the unique information of the clothing.

Herein, the unique information regarding the fabric may include a type and elasticity of a fiber, a thickness of fabric, a weight per area of the fabric, permeability of the fabric, a tensile strength, a tear strength, an abrasion strength, heat resistance, moisture mobility, firmness, drapability, peeling, filling, a spinning property, a strength of a thread, the spinning property, evenness of the thread, curving and bending characteristics, and fillability. Further, the unique information of the clothing may include the type, the use, a wearing portion, and the like of the clothing.

Further, as illustrated in FIG. 7, the step (S300) of adjusting the distance between the clothing cloud data includes a step (S301) of setting a reference point, a step (S302) of adjusting the distance between the reference points, a step (S303) of adjusting a detailed interval, a step (S304) of setting a movement direction, and a step (S305) of calculating a shape change.

In the step (S301) of setting the reference point, a plurality of reference points are set among the clothing point cloud data. The reference point may be set at a predetermined interval and set at a portion which becomes a joint according to the shape of the clothing.

In the step (S302) of adjusting the distance between the reference points, the distance between the reference points is calculated and the reference points are moved. In the step (S302) of adjusting the distance between the reference points, the distance between the reference points is calculated by combining the user point cloud data and the physical point cloud data and the reference points are moved according to the calculated distance.

In the step (S303) of adjusting the detailed interval, the distance between the respective point cloud data is adjusted from the reference point. In the step (S303) of adjusting the detailed interval, the distance between the respective point cloud data is adjusted from the reference point and even the distance between the point cloud data is adjusted.

The step (S303) of adjusting the detailed interval may include a step of calculating volumes of parts of the body of the user, a step of calculating stress applied to each part of the clothing, and a step of calculating an extensible distance according to a characteristic of the fabric.

In the step of calculating the volumes of the parts of the body of the user, the volume is analyzed by dividing the body of the user into the respective parts and for example, the volume may be analyzed by dividing the body of the user into an arm, a chest, a shoulder, an abdomen, and the like.

In the step of calculating the stress, the stress applied to the respective parts of the clothing is calculated. In the step of calculating the stress, a space which is accommodatable in the clothing is calculated and the stress applied to each clothing is calculated and stored when the body is inserted into the clothing by the calculated space.

In the step of calculating the stress, the stress applied to the respective point cloud data may be calculated. In the step of calculating the extensible distance according to the characteristic of the fabric, the distance which is extensible for each part of the clothing is calculated by considering the unique information of the fabric and the shape of the clothing.

In the step (S304) of setting the movement direction, a movement direction of the clothing point cloud data is set and the movement direction of the clothing point cloud data is calculated by considering the stress applied to the clothing and the shape of the clothing. The movement direction of the clothing point cloud data may be determined by the stress and the elasticity.

In the step (S305) of calculating the shape change, a plurality of curvature points which contact the body are extracted from the clothing point cloud data and a shape change of the clothing point cloud data is calculated at the curvature points. For example, the stress is not applied to the clothing by the body at a portion which contacts the shoulder, but the clothing droops by gravity, and as a result, the clothing shape is changed and in the step (S305) of calculating the shape change, a length of the clothing and the length of the body are compared with each other to calculate the shape change of the clothing.

In the step (S400) of generating the 3D manipulated data, the 3D manipulated data acquired by synthesizing the body and the clothing of the user is generated. In the step (S500) of generating the 3D manipulated image, the contour line is generated from the 3D manipulated data and the color is combined to generate the 3D manipulated image.

The step of generating the 3D manipulated image may include a step of synthesizing first clothing point cloud data representing the outer shape of first clothing with the point cloud data of the user and a step of synthesizing second clothing point cloud data representing the outer shape of second clothing after synthesizing the first clothing point cloud data. Further, the size of the clothing corresponding to the second clothing point cloud data may be calculated according to the size of the clothing corresponding to the first clothing point cloud data and the thickness of the first clothing.

Further, in the step of generating the 3D manipulated image, when at least two clothes corresponding to the clothing point cloud data to be synthesized with the user point cloud data are selected, the clothing point cloud data corresponding two clothes selected according to the unique information of the clothing may be automatically synthesized with the user point cloud data in sequence.

The method for generating the 3D manipulated image may further include a step of rotating the 3D manipulated image at a set rotational speed after the step of generating the 3D manipulated image. A motion of the clothing constituting the 3D manipulated image may be expressed according to the unique information of the clothing corresponding to the clothing point cloud data synthesized with the user point cloud data.

In the 3D manipulated image wearing the clothing, the image may be rotated by dragging a mouse or a touch screen of a user terminal. Further, as described above, the clothing selected by using the unique information of the clothing is automatically synchronized with a corresponding location in the user point cloud data.

Besides, the 3D manipulated image may be made by various methods. As one example, when the clothing is selected and worn in the user point cloud data, primarily selected clothing is automatically combined and synthesized. Thereafter, when secondarily selected clothing is worn, the primarily selected clothing is worn on the user point cloud data to synthesize the secondary selected clothing with the user point cloud data by considering an increased thickness. By such a method, the 3D manipulated image may be implemented in such a manner that subsequently selected clothing is worn on the exterior of the previously selected clothing. Such a method is applied to implement the same effect as a case where actual clothing is worn. Further, since the clothing which is worn on the exterior of the previously selected clothing is worn by considering the thickness of the previously selected clothing as the size of the clothing which is worn on the exterior of the previously selected clothing, the clothing point cloud data may preferably be changed in various shapes as described above.

When additionally described, since a part of the clothing made by a fabric which is excellent in elasticity is stretched due to the elasticity when the thickness of the previously selected clothing (clothing which is internally actuated) is small, clothing having a larger size by one step need not be synthesized. However, since the clothing made by the fabric which is low in elasticity is not stretched even though the thickness of the previously selected clothing is small, clothing having the larger size by one step (alternatively, two steps or more) needs to be synthesized. As such, according to the present invention, the 3D image is generated by using the unique characteristics of the clothing and the fabric.

When the clothing may be worn on the user point cloud data through dragging and when the clothing is clicked by the mouse if necessary, the clothing may be automatically synthesized with the corresponding location in the user point cloud data by using the unique information of the clothing.

The method for generating the 3D manipulated image may include a step of storing the generated 3D manipulated image. In the storing step, the 3D manipulated image may be stored in a separate storage space. That is, after multiple 3D manipulated images are stored in the storage space, the corresponding 3D manipulated image may be called up or provided to a third person if necessary. Additionally, according to the present invention, the selected 3D manipulate image is transmitted to a clothing making company, and as a result, the selected clothing may be requested to be made.

As described above, the user may store the synthesized 3D manipulated image in the separate storage space and call up the 3D manipulated image stored in the storage space of another person under permission of another person if necessary. When additionally described, the clothing point cloud data is extracted from a registered clothing image of another person and the manipulated image is generated by synthesizing the extracted clothing point cloud data with the user point cloud data. Of course, in this case, the unique information of the clothing is reflected to generate the manipulated image.

As described above, even in the case where the clothing point cloud data and the user point cloud data are the same as each other, when the unique information of the clothing is different, different 3D manipulated images are generated. Besides, if necessary, the clothing point cloud data may be modified based on the user point cloud data. That is, when the user desires to make clothing acquired by partially modifying ready-made clothing, the clothing point cloud data is modified based on the user point cloud data. As described above, when the clothing point cloud data is partially modified, it is more preferable to use the clothing point cloud data having a relatively smaller data capacity than to use the scan data. When additionally described, the clothing point cloud data is partially modified based on the user point cloud data to generate the 3D manipulated image.

The present invention has bee described with reference to the embodiment illustrated in the drawings, but this is just exemplary and it will be appreciated by those skilled in the art that various modifications and other embodiments equivalent thereto can be made therefrom.

### SEQUENCE LIST TEXT

100: System operator server

110: Clothing data generating unit

140: Input unit

120: 3D manipulated image generating unit

130: Control unit

131: Reference point setting unit

132: Reference point adjusting unit

133: Data detail adjusting unit

134: Direction calculating unit

135: Shape control unit

140: Input unit

150: Storage server

200: User scanner

205: 3D scanner

210: Input unit

215: Storage unit

220: Communication unit

225: Control unit

1. A method for generating a 3D manipulated image by combining physical image data and clothing image data of a user, the method comprising:
adjusting a distance between clothing cloud data by combining physical cloud data representing a body of a user, clothing cloud data representing clothing, unique information of fabric constituting the clothing, and the unique information of the clothing;
generating 3D manipulated data acquired by synthesizing the body and the clothing of the user; and
generating a contour line from the 3D manipulated data and generating colors to generate the 3D manipulated image.

2. The method for generating a 3D manipulated image of claim 1, the method further comprising:
generating user point cloud data representing an outer shape of the body of the user; and
generating clothing point cloud data representing the outer shape of the clothing,
wherein the physical cloud data and the clothing cloud data are constituted by point cloud data.

3. The method for generating a 3D manipulated image of claim 1, the method further comprising:
generating user mesh data representing the outer shape of the body of the user; and
generating clothing mesh data representing the outer shape of the clothing,
wherein the physical cloud data and the clothing cloud data are constituted by mesh data.

4. The method for generating a 3D manipulated image of claim 2, wherein in the generating of the user point cloud data, the user point cloud data is generated by scanning the body of the user.

5. The method for generating a 3D manipulated image of claim 4, wherein in the generating of the clothing point cloud data, the clothing point cloud data is generated by scanning the clothing.

6. The method for generating a 3D manipulated image of claim 2, wherein in the generating of the clothing point cloud data, the clothing point cloud data is generated from an input 3D image file of the clothing.

7. The method for generating a 3D manipulated image of claim 2, wherein the adjusting of the distance between the clothing cloud data includes
setting a plurality of reference points in the clothing point cloud data,
adjusting the distance between the reference points, and
adjusting a detailed interval of adjusting the distance between respective point cloud data from the reference point.

8. The method for generating a 3D manipulated image of claim 7, wherein the adjusting of the detailed interval includes
calculating volumes of parts of the body of the user,
calculating stress applied to each part of the clothing, and
calculating an extensible distance according to a characteristic of the fabric.

9. The method for generating a 3D manipulated image of claim 7, wherein the adjusting of the distance between the clothing cloud data includes setting a movement direction of the clothing point cloud data.

10. The method for generating a 3D manipulated image of claim 7, wherein in the adjusting of the distance between the clothing cloud data, a plurality of curvature points which contact the body are extracted from the clothing point cloud data and a shape change of the clothing point cloud data is calculated at the curvature points.

11. The method for generating a 3D manipulated image of claim 1, wherein the unique information regarding the fabric is at least one of a type and elasticity of a fiber, a thickness of fabric, a weight per area of the fabric, permeability of the fabric, a tensile strength, a tear strength, an abrasion strength, heat resistance, moisture mobility, firmness, drapability, peeling, filling, a spinning property, a strength of a thread, the spinning property, evenness of the thread, curving and bending characteristics, and fillability.

12. The method for generating a 3D manipulated image of claim 2, wherein the generating of the 3D manipulated image includes
synthesizing first clothing point cloud data representing the outer shape of first clothing with the point cloud data of the user, and
synthesizing second clothing point cloud data representing the outer shape of second clothing after synchronizing the first clothing point cloud data,
wherein the size of the clothing corresponding to the second clothing point cloud data is calculated according to the size of the clothing corresponding to the first clothing point cloud data and the thickness of the first clothing.

13. The method for generating a 3D manipulated image of claim 12, further comprising:
after the generating of the 3D manipulated image,
rotating the 3D manipulated image at a set rotational speed,
wherein a motion of the clothing constituting the 3D manipulated image is expressed according to the unique information of the clothing corresponding to the clothing point cloud data synthesized with the user point cloud data.

14. The method for generating a 3D manipulated image of claim 2, further comprising:
receiving the unique information of the user,
wherein the unique information of the user is at least one of an age, a gender, a hair color, and a weight of the user.

15. The method for generating a 3D manipulated image of claim 2, wherein in the generating of the 3D manipulated image, when at least two clothes corresponding to the clothing point cloud data to be synthesized with the user point cloud data are selected, the clothing point cloud data corresponding two clothes selected according to the unique information of the clothing is automatically synthesized with the user point cloud data in sequence.

16. A system for generating a 3D manipulated image, the system comprising:
a user scanner generating user point cloud data representing an outer shape of a body from data acquired by scanning body of a user and transmitting the generates user point cloud data and unique information of the user; and
a system operator server generating the 3D manipulated image acquired by synthesizing the body and clothing of the user by combining the user point cloud data, clothing point cloud data, received unique information of fabric constituting the clothing, and the unique information of the clothing.

17. The system for generating a 3D manipulated image of claim 16, wherein the system operator server includes a clothing point cloud data generating unit generating clothing point cloud data representing an outer shape of the clothing from data acquired by scanning the clothing.

18. The system for generating a 3D manipulated image of claim 16, wherein the system operator server includes
a reference point setting unit setting a plurality of reference points in the clothing point cloud data,
a reference point adjusting unit adjusting a distance between the reference points, and
a point cloud data detail adjusting unit adjusting the distance between respective point cloud data from the reference point.

19. The system for generating a 3D manipulated image of claim 18, wherein the point cloud data detail adjusting unit includes a physical analyzing unit calculating volumes of parts of the body of the user, a stress calculating unit calculating stress applied to each part of the clothing, and an elasticity calculating unit calculating an extensible distance of the clothing.

20. The system for generating a 3D manipulated image of claim 17, wherein the system operator server further includes a shape control unit,
wherein the shape control unit extracts a plurality of curvature points which contact the body from the clothing point cloud data and calculates a shape change of the clothing point cloud data at the curvature points.
